(19) United States
(12) Patent Application Publication
(10) Pub. No.: US 2022/0081180 A1
(43) Pub. Date: Mar. 17, 2022

(54) PACKAGING DEVICE AND PACKAGING TRACTION DEVICE, AND METHOD FOR USING SAME

(71) Applicant: GUANGZHOU OO MEDICAL SCIENTIFIC LIMITED, Guangzhou, Guangdong (CN)

(72) Inventors: Qinhui ZHANG, Guangzhou, Guangdong (CN); Li JI, Guangzhou, Guangdong (CN)

(21) Appl. No.: 17/419,602

(22) PCT Filed: Dec. 27, 2019
(86) PCT No.: PCT/CN2019/128964

§ 371 Date: Jun. 29, 2021

(30) Foreign Application Priority Data
Dec. 29, 2018 (CN) 201811641395.8

(51) Int. Cl. B65D 77/04; B65D 77/22; A61C 7/12

(52) U.S. Cl. CPC B65D 77/04; B65D 77/22; A61C 2202/00; B65D 2577/043; A61C 7/12

(57) ABSTRACT

A packaging device containing at least one placing cavities and containers of orthodontic bracket. The containers of orthodontic bracket can be connected in series, and the containers of orthodontic bracket which have been connected in series can be placed in the placing cavities. The container of orthodontic bracket includes a placement portion, and the orthodontic brackets can be placed in the containers. The packaging device of the present invention provides containers that can specifically fix the orthodontics brackets and can be connected in series. The containers that have been connected in series can be placed in the placing cavities of the package to reduce space. The compact package is convenient for large-scale transportation.

### BACKGROUND OF THE INVENTION

### 1. Field of the Invention

The present invention relates to the packaging of orthodontic devices, in particular to a packaging device and a guiding packaging device, and a method of use thereof.

### 2. Background

A bracket is an important component of orthodontic correction technology. The arch wire exerts various forces on the teeth through the brackets. The main function of the brackets is to fix the arch wire, so that the arch wire can better play its role and transmit the force to control the three-dimensional movement of teeth achieves the purpose of orthodontic correction. The bracket packaging box is a box used to pack the brackets, which can ensure the safety of the product during transportation and improve the grade of the product.

When the brackets are packaged, the brackets are packaged according to the set of brackets required by one patient. Each patient is expected to use a package of brackets. However, in transportation, the transportation of a package of a set of brackets is not economical, it is a waste of money. Doctors in hospitals or clinics often need to use several packages of brackets within a day, and need to open and close the packages of brackets frequently, which reduces the efficiency of orthodontic correction. If one bracket in the package of brackets is missing, the entire set of brackets are wasted and cannot be used by the patient, resulting in waste of resources and economic loss.

Existing bracket package is mainly composed of a box body, a cover body and an inner holder. The inner holder is set in the box body. The inner holder is provided with a bracket placement slot. The bracket is placed in the bracket placement slot. During the process of the doctor performing orthodontic correction, doctors need to use a clamping tool to get the bracket out from the bracket placement slot, and then bond the bracket to the tooth. However, because the bracket placement slot cannot hold the brackets still, the brackets can move and rotate freely in the bracket placement slot, so that doctors need to adjust the angle of the bracket before picking up the disorganized brackets. During the process of adjusting the angle of the bracket, the brackets may fall or get lost, making it difficult for doctors to operate.

### SUMMARY OF THE INVENTION

The purpose of the present invention is to overcome the defects of the prior art by providing a container for the brackets that can specifically hold the brackets still and can be connected in series. The containers of brackets connected in series can be placed in the packaging device. The design of the packaging device can help reducing the space, it is convenient to use it for large-scale transportation.

The technical scheme of the present invention is as follows:

A packaging device, comprising:

a placing cavity having a first port and a second port,

containers of brackets that can be sequentially connected in series to form a bracket storage group, and the containers of brackets can be placed in the placing cavity,

the container of bracket in the bracket storage group can be taken out from the first port separately, and the container of bracket which has been taken out can be reconnected to the bracket storage group through the first port or the second port.

In one embodiment, the packaging device includes more than one placing cavities, and the placing cavities are arranged in the order of tooth position.

In another embodiment, the containers of the brackets of one tooth position are sequentially connected in series, and can be placed in the placing cavity of the same tooth position.

In another embodiment, the container of bracket closely fits with the placing cavity in the axial direction of the placing cavity.

In another embodiment, the container of bracket includes a box body and a placement portion, an upper end of the box body is provided with a protruding part, the protruding part includes a convex, a top surface of the convex has a first cavity recessed downward,

a lower end of the box body is provided with a covering portion, the covering portion includes a covering cavity, the convex and the covering cavity are matched in size,

the placement portion is provided at the first cavity, and the bracket can be placed in the placement portion.

In another embodiment, the placement portion includes a bracket placement slot having a placement opening, a placement side, and a placement bottom, and the placement side includes a first placement side and a second placement side.

In another embodiment, an outer wall of the convex has external threads or buckling protrusions, and the covering cavity has internal threads or buckling grooves.

In another embodiment, an inner wall of the placing cavity is provided with a locking protrusion or a locking groove, and an outer wall of the container of bracket is provided with another locking groove or another locking protrusion, and the locking protrusion matches the locking groove.

In another embodiment, the placing cavity or the container of bracket has different tooth position marks and/or color marks corresponding to each tooth position.

A guiding packaging device, comprising:

the aforementioned packaging device,

a traction rope, both ends of the traction rope face the same direction,

an inner wall of the placing cavity is provide with symmetrical traction grooves,

one end of the traction rope is fixed to the cavity opening of the placing cavity. The aforementioned guiding packaging device, wherein the second port can be closed.

A method of use the aforementioned packaging device, comprising:

putting the containers of brackets in the packaging device, or taking it out from the packaging device.

A method of use the aforementioned guiding packaging device, comprising:

putting the containers of brackets in the packaging device, or taking it out from the packaging device.

The beneficial effects that the present invention can provide are as follows:

1. In some embodiments, a number of containers of brackets for the same tooth position can be sequentially connected in series and can be placed in the placing cavity of the same tooth position. The placing cavity can accommodate a large number of containers of brackets, so it can save the storage space of the containers of brackets. And the package is very convenient for large-scale transport.

2. In some other embodiments, a complete container set can be formed by the containers of brackets of each tooth position. (An entire container set includes one container for bracket for each tooth position) A complete container set can be sequentially connected in series and placed in one placing cavity. One placing cavity can accommodate a container set, that is a set of brackets, so that doctors can get the brackets by the tooth position order easily.

3. When one places the containers of brackets of the same tooth position which have been connected in series in the placing cavity of the same tooth position, the package can pack more than one sets of brackets, and the package can accommodate more than one sets of brackets, bringing convenience to storage and transportation.

4. The container of bracket has a placement portion, which can specifically hold a bracket still, so that the bracket will not move. And the brackets in the bracket placement slot can be placed at an angle suitable for doctors' gripping, bring convenience for the doctors' operation.

5. The containers of brackets for different tooth positions have different color marks and/or tooth position, so that doctors can identify and collect easily. When the containers of brackets for different tooth positions are connected in series, because containers of brackets for different tooth positions have different color marks and/or tooth position, the doctors can quickly find what they need from the set of the containers of brackets.

6. When the containers of brackets are connected in series with each other, the convex of one container of bracket can be matched with the covering cavity of another container of bracket. No need to add other connector, the containers of brackets can be connected by themselves. The structure is simple, and the operation is convenient.

7. When the containers of brackets are connected in series with each other, the convex on the upper end of one of the container of bracket can be connected to the covering cavity on the lower end of another container of bracket by screwing or buckling. So that the containers of brackets can be firmly connected without loosening and falling off.

8. The radial shape and size of the placing cavity is the same with the radial shape and size of the container of bracket. The axial length of the placing cavity is much larger than the axial length of the container of bracket, so that the placing cavity can accommodate multiple containers of brackets.

9. In the packaging device, multiple placing cavities are arranged in the order of tooth positions, and the placing cavity of each tooth position has different tooth position marks and/or color marks, so that it is easy to identify and find the required brackets, and the efficiency of doctor operation can be strongly improved.

10. In some embodiment, the containers of brackets of the same tooth position are connected in series and placed in the placing cavity of the same tooth position. When the user operates, the bracket of the desired tooth position can be found by identifying the tooth position marks.

11. When there are surplus brackets in the packaging device, and these surplus brackets can't make a complete set of brackets, you can take out the surplus containers of brackets with the brackets, connect them in series, and use the enclosed space formed by the series connection to store some brackets.

12. The inner wall of the placing cavity is provided with a locking protrusion, and the outer wall of the container of bracket is provided with a locking groove. The locking protrusion and the locking groove match each other. The containers of brackets which have been connected in series can slide into the placing cavity for storage. The locking protrusions and the locking grooves can prevent the containers of brackets from moving and rotating in the placing cavity and maintain the stability of the package.

13. The traction rope is convenient for the user to take out the container of bracket placed in the placing cavity. Pull the traction rope to drive the container of bracket to protrude from the placing cavity, and then out of the placing cavity.

14. When there are surplus brackets in the packaging device, and these surplus brackets can't make a complete set of brackets, you can take out the surplus containers of brackets with the brackets, connect them in series, and use the enclosed space formed by the series connection to protect some brackets. It makes the brackets clean and hygienic, and at the same time avoids the fate of discarding the remaining brackets like ordinary bracket packages, and saves costs.

15. When there are surplus brackets, you can take out the containers of brackets containing the surplus brackets, the surplus containers of brackets can be connected in series, and can be placed separately. Then the surplus will not waste space.

### BRIEF DESCRIPTION OF THE DRAWINGS

FIG. 1 is a perspective view of the packaging device according to an embodiment of the present invention.

FIG. 2 is a diagram of the container of the packaging device of the embodiment of the present invention.

FIG. 3 is a partial view of the guiding packaging device according to the embodiment of the present invention.

FIG. 4 is a partial cross-sectional view of the placing cavity of the packaging device according to the embodiment of the present invention.

FIG. 5 is a schematic diagram of the container of bracket of the packaging device of the embodiment of the present invention.

FIG. 6 is a schematic diagram of the series connection of the container of bracket of the packaging device of the embodiment of the present invention.

FIG. 7 is a schematic diagram of the bracket placement portion of the packaging device of the embodiment of the present invention.

FIG. 8 is another schematic diagram of the bracket placement portion of the packaging device of the embodiment of the present invention.

FIG. 9 is a cross-sectional view of the bracket placement portion of the packaging device of the embodiment of the present invention.

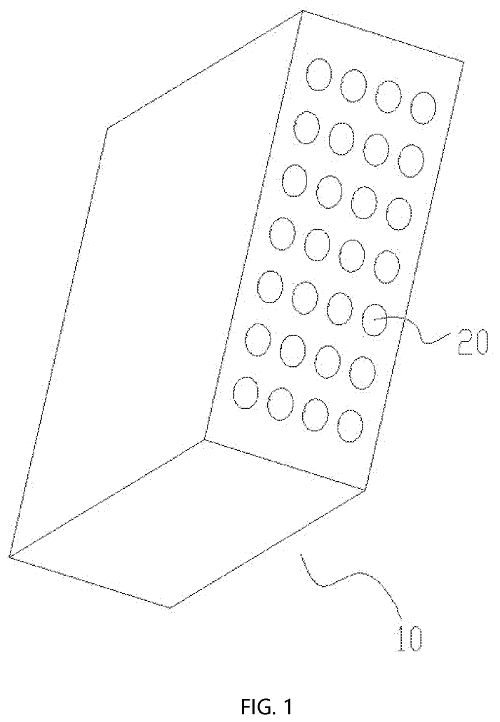

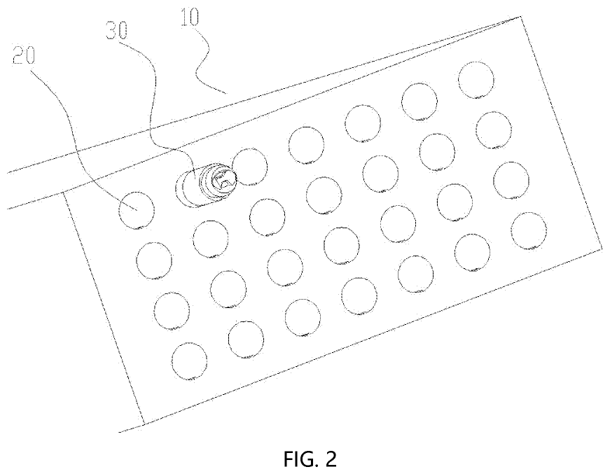

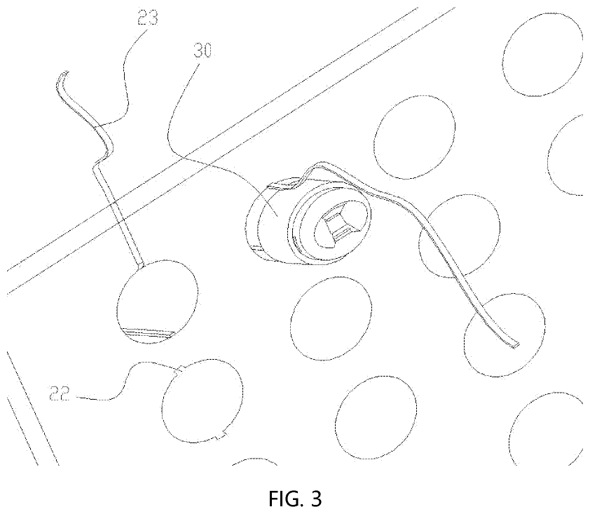

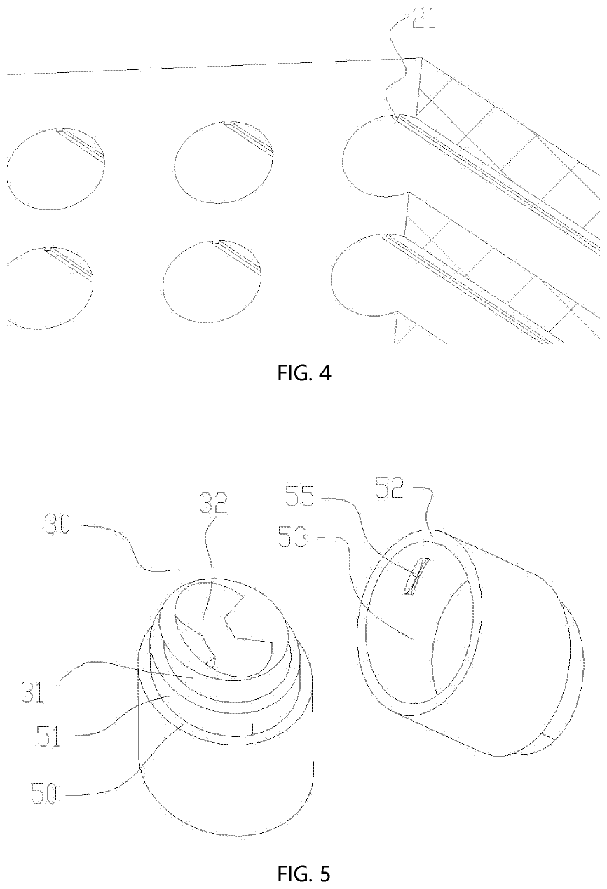

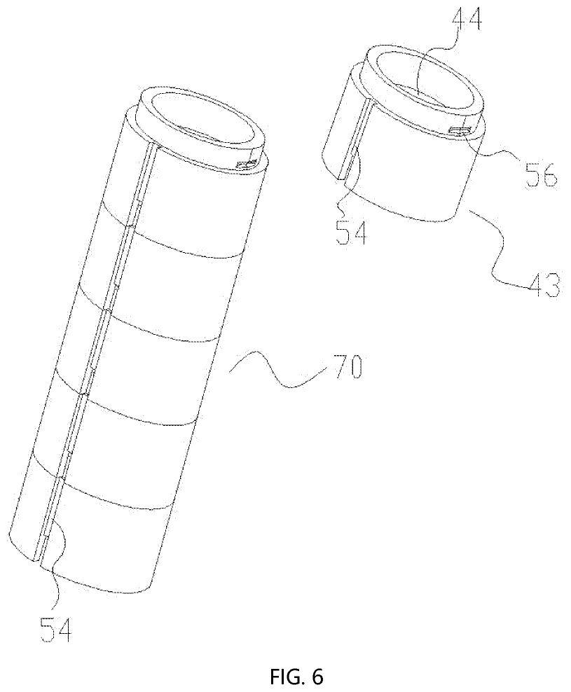

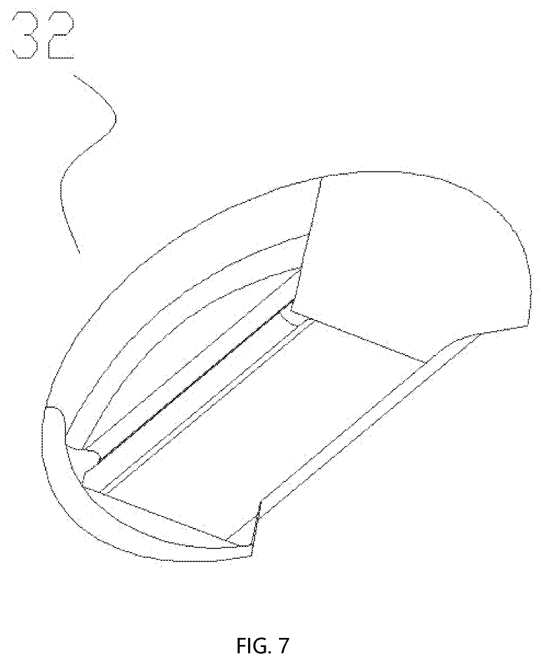

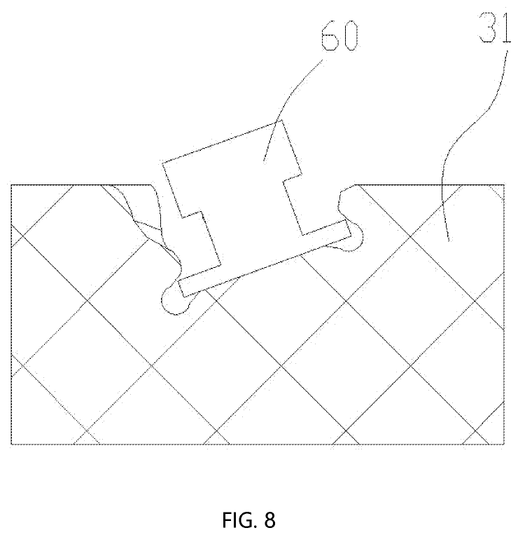

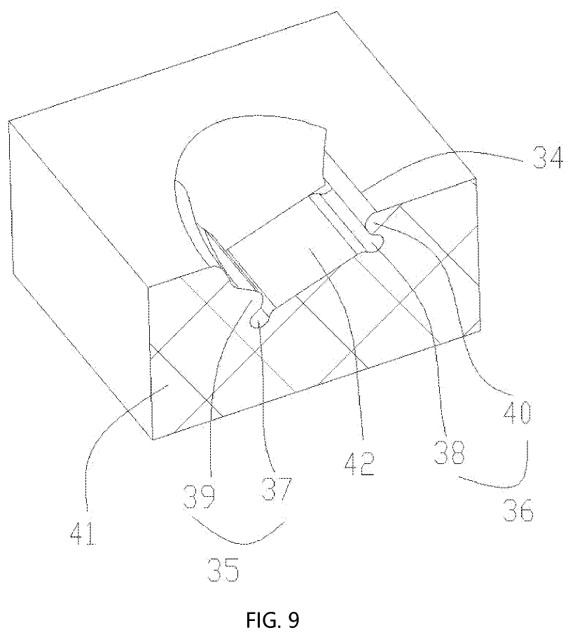

### DESCRIPTION OF REFERENCE SIGNS IN THE DRAWINGS

10. packaging device; 20. Placing cavity; 21. Locking Protrusion; 22. Traction Grooves; 23. Traction Rope; 30. Container of Bracket; 31. Placement Portion; 32. Bracket Placement Slot; 34. Placement Opening; 35. First Placement Side; 36, Second Placement Side; 37. First Side Recess; 38. Second Side Recess; 39. First Positioning Protrusion; 40. Second Positioning Protrusion; 41. Supporting Portion; 42. Placement Bottom; 43. Box Body; 44. First Groove; 50. First Surface; 51. Convex; 52. second surface; 53. covering cavity; 54. Locking Groove; 55. Buckling Protrusion; 56. Buckling Groove; 60. Bracket; 70. Bracket Storage Group.

### DETAILED DESCRIPTION

A packaging device 10, comprising:

a placing cavity 20 and containers of brackets 30 that can be sequentially connected in series to form a bracket storage group 70, and the bracket storage group 70 can be placed in the placing cavity 20.

The container of bracket 30 includes a box body 43 and a placement portion 31.

The box body 43 has two ends, an upper end and a lower end. The upper end has a protrusion. The top surface of the protrusion is the first surface 50. The protrusion includes a convex 51 that protrudes from the first surface 50. The convex 51 has an outer side wall (or the outer side wall of the convex 51 has an external thread or a buckling protrusion 55), and the top surface of the convex 51 is recessed downward to form a first groove 44.

The lower end has a covering portion at the lower end, and the bottom surface of the covering portion is provided with a second surface 52 that matches with the first surface 50. The first surface 50 and the second surface 52 have the same shape and size, and the second surface 52 is recessed in the upper end direction to form a covering cavity 53. The covering cavity 53 has an inner wall (or the inner wall of the covering cavity 53 has an internal thread or a buckling groove 56), and the depth of the covering cavity 53 is deeper than or equal to the height of the convex 51.

An outer side wall of the box body 43 is provided with a locking groove 54 parallel to the central axis of the box body 43. The locking groove 54 extends from the protrusion at the upper end to the bottom end of the lower end. There are one or more locking grooves 54.

The box body 43 has a color mark and/or a tooth position mark. The box body 43 of the containers of brackets 30 for the brackets 60 of different tooth positions have different colors. For example, the box body 43 of 11-tooth position is white, and the box body 43 of 12-tooth position is white. The box body 43 of the 13-tooth position is red, the box 43 of the 13-tooth position is green . . . . The containers of brackets 30 corresponding to the brackets 60 of different tooth positions have different tooth position marks, and the box body 43 is marked with the tooth position number so that the doctor can identify it. The color mark and tooth position mark of the box body 43 can be used alone or in combination.

The container of bracket 30 includes a placement portion 31 that matches with the first groove 44 of the box body 43, and the placement portion 31 is placed in the first groove 44. The placement portion 31 includes a supporting portion 41 and a bracket placement slot 32.

The bracket placement slot 32 has a placement opening 34, a placement side, and a placement bottom 42, the placement side of the bracket placement slot 32 has a top edge and a bottom edge. The top edge of the placement side of the bracket placement slot 32 is connected with the placement opening 34 of the placement slot 32. And the bottom edge of the placement side of the bracket placement slot 32 is connected with the placement bottom 42 of the bracket placement slot 32.

The placement side of the bracket placement slot 32 includes a first placement side 35 and a second placement side 36, and the first placement side 35 is opposite to the second placement side 36.

A first side recess 37 is provided between the first placement side 35 and the placement bottom 42 of the bracket placement slot 32, and a second side recess is provided between the second placement side 36 and the placement bottom 42 of the bracket placement slot 32.

The first placement side 35 is provided with a first positioning protrusion 39 at its bottom edge. The first positioning protrusion 39 protrudes from the second placement side portion 36 relative to the first placement side portion 35. And there is a positioning gap between the first positioning protrusion 39 and the placement bottom 42 of the bracket placement slot 32. The second placement side 36 is provided with a second positioning protrusion 40 at its bottom edge. The second positioning protrusion 40 protrudes from the first placement side 35, and there is a positioning gap between the second positioning protrusion 40 and the placement bottom 42 of the bracket placement slot 32. The first positioning protrusion 39 is opposed to the second positioning protrusion 40. The first positioning protrusion 39 and the second positioning protrusion 40 hold the bracket 60 still, so that the bracket 60 can be placed firmly in the bracket placement slot 32.

The arrangement of the bracket placement slot 32 makes the first positioning protrusion 39 and the second positioning protrusion 40 of the bracket placement slot 32 engage with the bracket oppositely, so that the bracket 60 can be stably placed in the bracket placement slot 32. And the brackets in the bracket placement slot 32 can be placed at an angle suitable for doctors' gripping, speeding up the treatment process.

The supporting portion 41 of the placement portion 31 is tightly fitted or interference fit or fixedly fitted with the first groove 44 of the container of bracket 30, and the bottom of the supporting portion 41 is matched with the bottom of the first groove 44. The supporting portion 41 can be fixed in the first groove 44. The bracket placement slot 32 protrudes from the first groove 44 to facilitate installation or clamping of the bracket 60.

When there are two or more containers of brackets 30, the containers of brackets 30 can be connected in series to form a bracket storage group 70. When containers of brackets 30 are connected in series to form a first bracket storage group, one of containers of brackets 30 is the first container of bracket, and the other one is a second container of bracket. The protruding portion of the upper end of the box body 43 of the first container of bracket can be connected and matched with the covering portion of the lower end of the box body 43 of the second container of bracket.

The convex 51 of the first container of bracket and the covering cavity 53 of the second container of bracket are tightly fitted or interference fit, threaded or snap-fitted, so that the first container of bracket and the second container of bracket connect tightly.

The depth of the covering cavity 53 of the container of bracket 30 is deeper than or equal to the height of the convex 51 of the container of bracket 30, so that the covering cavity 53 can cover the convex 51 of the second container of bracket completely.

At the same time, the first surface 50 of the first container of bracket and the second surface 52 of the second container of bracket match with each other. The first surface 50 and the second surface 52 have the same shape and size. The first container of bracket and the second container of bracket are tightly connected, so that the connection gap when the containers of brackets 30 are connected in series is minimized. The containers of brackets 30 are tidy and clean, so that the brackets located in the containers of brackets 30 does not get contaminated.

The first container of bracket can be connected in series with any one or two container of bracket 30 to form a second or third bracket storage group. The second or third container of bracket can be connected with any one or two container of bracket 30 . . . . The N0.N−1 container of bracket can be connected in series with any one or two container of bracket 30 to form the Number N container of bracket or Number N+1 container of bracket, the containers of brackets can be continuously connected in series.

The packaging device 10 is provided with a placing cavity 20, and the placing cavity 20 can accommodate the bracket storage group 70.

The shape and size of the cross section of the placing cavity 20 is consistent with the shape and size of the cross section of the container of bracket 30, that is, the container of bracket storage 30 can closely fit with the placing cavity 20 in the axial direction, so that the placing cavity 20 can hold the container of bracket 30 still. The container of bracket 30 will not move randomly in the placing cavity 20.

The placing cavity 20 can accommodate the container of bracket 70 in the axial direction of the placing cavity. Each placing cavity 20 can accommodate a large number of containers of brackets 30, so that the packaging device 10 can accommodate a large number of containers of brackets 30. The packaging device can reduce the waste of space, and facilitate large-scale transportation and use.

Further, the inner wall of the placing cavity 20 is provided with a locking protrusion 21 that matches with the locking groove 54 on the outer side wall of the container of bracket 30, and the number of the locking protrusions 21 can be one or more. The locking protrusion 21 on the inner wall of the placing cavity 20 and the locking groove 54 on the container of bracket 30 are engaged with each other, so that the container of bracket 30 can be stably placed in the placing cavity 20. And the container of bracket 30 will not move in the placing cavity 20. In other embodiments, the inner wall of the placing cavity 20 is provided with a locking groove 54, and the outer side wall of the container of bracket 30 is provided with a locking protrusion 21, and the locking groove of the placing cavity 20 is engaged with the locking protrusion of the container of bracket 30. Therefore, the container of bracket 30 can be stably placed in the placing cavity 20 and will not move randomly in the placing cavity 20.

There are multiple placing cavities 20 on the packaging device 10, and the multiple placing cavities 20 are arranged in the order of tooth positions. The placing cavity 20 has color marks and/or tooth position marks. The placing cavities 20 for the brackets 60 of different tooth positions have different colors. For example, the placing cavity 20 for the No. 11 tooth position is white, and the placing cavity 20 for the No. 12 tooth position is red. The placing cavity 20 of No. 13 tooth position is green . . . . The placing cavity 20 for the brackets 60 of different tooth positions has different tooth position marks, and the placing cavity 20 is marked with the tooth position number for the doctor to identify. The color mark and tooth position mark of the placing cavity 20 can be used alone or in combination.

Further, the placing cavity 20 of the packaging device 10 is a long through hole, which facilitates taking out the containers of brackets 30 from any one of the two ends of the placing cavity 20. A force can be applied from one end of the placing cavity 20 to the bracket storage group 70 placed therein, so that the bracket storage group 70 can protrude from the other end of the placing cavity 20, so that the containers of brackets can be taken out from the placing cavity 20.

Further, the bracket storage group 70 is placed in the placing cavity 20, the bracket storage group 70 extends from one end to the other end of the placing cavity 20, and the placing cavity 20 may be a long through hole.

Further, when the bracket storage group 70 is placed and filled in the long through-hole-shaped placing cavity 20, one container of bracket 30 (first container of bracket) is connected to the bracket storage group 70. A force is applied to the first container of bracket that has just been connected to the bracket storage group 70, so that the first container of bracket moves into the placing cavity 20, then the container of bracket 30 at the other end of bracket storage group 70 (second bracket storage box) protrudes out of the placing cavity 20. Then the second container of bracket can be removed from the end of the bracket storage group 70. When you want to take the container of bracket 30 out from the bracket storage group 70, you can connect the second container of bracket with the bracket storage group 70, then apply a force to the second container of bracket to make the container of bracket at an end of the bracket storage group 70 protrudes out of the placing cavity 20, then take the container of bracket protruding out of the placing cavity. The packaging device 10 and the containers of brackets 30 are recyclable, and no extra tools are needed to take the containers of brackets 30 out from the bracket storage group 70 in the placement cavity 20. The operation is simple and no extra tools needed. The packaging device 10 has a simple structure, which is convenient for doctors to use, and is suitable for a large number of storage containers of brackets 30.

In one embodiment, a complete set of containers of brackets 30 (that is, there is one container of bracket for each tooth position, thus forming a complete set) are connected in series and placed in the placing cavity 20 of the packaging device 10. Since there are several placing cavities 20, the packaging device 10 can accommodate several sets of containers of brackets 30, so that the packaging device 10 can package the brackets on a large scale, which is convenient for transportation and later use by doctors.

In one embodiment, the containers of brackets 30 of the same tooth position are connected in series and placed in the placing cavity 20 of the packaging device 10. The number of the placing cavities 20 is the number of the tooth positions or a multiple of the number of the tooth positions. So the packaging device 10 can accommodate several sets of containers of brackets 30. When used by the doctor, it can easily distinguish the placing cavity 20 where the required brackets are located, and then distinguish the containers of brackets 30 where the brackets 60 are located. Reduce the difficulty of finding the bracket 60, speed up the treatment process, and improve the patient's treatment experience. The packaging device 10 can accommodate several sets of containers of brackets 30, so that the packaging device 10 can package the brackets 60 on a large scale, which is convenient for transportation, saves transportation costs, and improves economic benefits.

In one embodiment, the placing cavity 20 of the packaging device 10 is further provided with two traction groove 22, and the traction grooves 22 are symmetrical to each other along the central axis of the placing cavity 20. The placing cavity 20 is also provided with a traction rope 23, the traction rope 23 is placed in the traction groove 22. Both ends of the traction rope 23 are facing the cavity opening at the same end of the placing cavity 20. The traction rope 23 along the traction groove 22 on one side of the placing cavity 20 extends through the cavity bottom of the placing cavity 20 to the other side of the traction groove 22 and finally extends out of the placing cavity 20. One end of the traction rope 23 is fixed to the cavity opening of the placing cavity 20, and the other end extends out of the cavity opening. 23 is arranged in an arch shape in the placing cavity 20.

When the bracket storage group 70 is placed in the placing cavity 20 of the packaging device 10, one end of the bracket storage group 70 is in contact with a traction rope segment located at the bottom of the placing cavity 20. Two traction rope segment in the symmetrical traction grooves at the side of the placing cavity are separately in contact with the side walls of bracket storage set. Both ends of the traction rope 23 are facing the cavity opening of the placing cavity 20, and one end of the traction rope 23 is fixed to the cavity opening of the placing cavity 20, the other end of the traction rope 23 freely protrudes out of the cavity opening of the placing cavity 20. When an outward force is applied to the traction rope 23 freely extending out of the placing cavity 20, the traction rope 23 moves toward the cavity opening of the placing cavity 20, and the traction rope 23 drives the bracket storage group 70 to move toward the opening of the placing cavity 20. That is, the traction rope section at the bottom of the placing cavity 20 exerts a force on the bracket storage group 70 toward the cavity opening of the placing cavity 20, so that the bracket storage group 70 moves to the cavity opening of the placing cavity 20. When the bracket storage group 70 protrudes from the cavity opening of the placing cavity 20, the user can remove the container of bracket 30. The packaging device 10 is simple to operate, and the traction rope 23 can be used to continuously take out the container of bracket 30 of the bracket storage group 70 located in the placing cavity 20, which is convenient for the operation of the doctor. The installation is convenient. The operator only needs to insert the bracket storage group 70 into the placing cavity 20 to complete the installation. The installation is simple, operation time is saved, and work efficiency is improved.

Further, the placing cavity 20 has a first port and a second port. In this embodiment, the first port or the second port can be closed.

In one embodiment, the packaging device 10 and the guiding packaging device further have an outer packaging box for packaging the packaging device 10 and the guiding packaging device, so that the packaging device 10 and the guiding packaging device can be packaged and transported well, and the packaging device 10 And the guiding packaging device is more beautiful.

The aforementioned “first, second . . . ” does not represent a specific number or order, but is only used to distinguish names.

The above-mentioned embodiments only express the implementation of the present invention, and the description is relatively specific and detailed, but it should not be understood as a limitation to the patent scope of the present invention. It should be pointed out that for those of ordinary skill in the art, without departing from the concept of the present invention, several modifications and improvements can be made, and these all fall within the protection scope of the present invention. Therefore, the protection scope of the patent of the present invention should be subject to the appended claims.

1. A packaging device, comprising:
a placing cavity having a first port and a second port,
containers of brackets that can be sequentially connected in series to form a bracket storage group, and the containers of brackets can be placed in the placing cavity,
the container of bracket in the bracket storage group can be taken out from the first port separately, and the container of bracket which has been taken out can be reconnected to the bracket storage group through the first port or the second port.

2. The packaging device according to claim 1, wherein the packaging device includes more than one placing cavities, and the placing cavities are arranged in the order of tooth position.

3. The packaging device according to claim 2, wherein the containers of the brackets of one tooth position are sequentially connected in series, and can be placed in the placing cavity of the same tooth position.

4. The packaging device according to claim 1, wherein the container of bracket closely fits with the placing cavity in the axial direction of the placing cavity.

5. The packaging device according to claim 1, wherein the container of bracket includes a box body and a placement portion, an upper end of the box body is provided with a protruding part, the protruding part includes a convex, a top surface of the convex has a first cavity recessed downward,
a lower end of the box body is provided with a covering portion, the covering portion includes a covering cavity, the convex and the covering cavity are matched in size,
the placement portion is provided at the first cavity, and the bracket can be placed in the placement portion.

6. The packaging device according to claim 5, wherein the placement portion includes a bracket placement slot having a placement opening, a placement side, and a placement bottom, and the placement side includes a first placement side and a second placement side.

7. The packaging device according to claim 5, wherein an outer wall of the convex has external threads or buckling protrusions, and the covering cavity has internal threads or buckling grooves.

8. The packaging device according to claim 5, wherein an inner wall of the placing cavity is provided with a locking protrusion or a locking groove, and an outer wall of the container of bracket is provided with another locking groove or another locking protrusion, and the locking protrusion matches the locking groove.

9. The packaging device according to claim 1, wherein the placing cavity or the container of bracket has different tooth position marks and/or color marks corresponding to each tooth position.

10. A guiding packaging device, comprising:
the packaging device according to claim 1,
a traction rope, both ends of the traction rope face the same direction,
an inner wall of the placing cavity is provide with symmetrical traction grooves,
one end of the traction rope is fixed to the cavity opening of the placing cavity.

11. The guiding packaging device according to claim 10, wherein the second port can be closed.

12-13. (canceled)
